(19) United States
(12) Patent Application Publication
(10) Pub. No.: US 2021/0078062 A1
(43) Pub. Date: Mar. 18, 2021

(54) PUNCHING APPARATUS

(71) Applicant: Panasonic Intellectual Property Management Co., Ltd., Osaka (JP)

(72) Inventors: MASAYUKI TAKAHASHI, Osaka (JP); KEITARO FUJII, Osaka (JP)

(21) Appl. No.: 16/997,035

(22) Filed: Aug. 19, 2020

(30) Foreign Application Priority Data
Sep. 18, 2019 (JP) 2019-169540

(51) Int. Cl. B21C 51/00; B21D 22/02

(52) U.S. Cl. CPC B21C 51/00; B21D 22/02

(57) ABSTRACT

A punching apparatus according to the present disclosure includes a punch and a die for forming a punching die for punching a predetermined shape from a workpiece, and performs a punching process for punching a shape of the punching die by the punch from the workpiece positioned on the die, the punching apparatus including a detection device and a determination device. The detection device includes measurers and acquires a horizontal component force generated in a direction of each of two axes orthogonal to each other in a plane orthogonal to an axis along a punching direction of the punch, among forces generated when the workpiece measured by the measurers is punched. The determination device determines whether or not a defect occurs in the punch or the die based on the horizontal component force acquired by the detection device.

### BACKGROUND

### 1. Technical Field

The present disclosure relates to a punching apparatus, and specifically to a punching apparatus for punching a flat plate of metal, plastic, composite material, or the like.

### 2. Description of the Related Art

In the related art, as this type of punching apparatus, there is a load monitoring device of a press including a calculation device for comparing a punching load in actual press work with a load stored in a storage device, and a device for displaying a calculation result (for example, see Japanese Patent Unexamined Publication No. 55-48628).

In a configuration view of the punching apparatus of the related art, a load detection sensor is installed in a lower portion of the punching apparatus to detect a processing resistance at the time of a punching process. It is said that a strain gauge or the like is preferable as the load detection sensor. A signal from the load detection sensor is amplified and transmitted to a CPU unit. In the CPU unit, the signal received from the load detection sensor is calculated and converted into a load. The CPU unit compares a load value in the actual punching process with a limit value, calculates a difference therebetween, and displays a calculation result on the display device.

### SUMMARY

A punching apparatus according to the present disclosure, which includes a punch and a die for forming a punching die for punching a predetermined shape from a workpiece, and performs a punching process for punching a shape of the punching die by the punch from the workpiece positioned on the die, the punching apparatus including: a detection device that includes a plurality of measurers and acquires a horizontal component force generated in a direction of each of two axes orthogonal to each other in a plane orthogonal to an axis along a punching direction of the punch, among forces generated when the workpiece measured by the plurality of measurers is punched; and a determination device that determines whether or not a defect occurs in the punch or the die based on the horizontal component force acquired by the detection device.

### BRIEF DESCRIPTION OF THE DRAWINGS

FIG. 1 is a partial front sectional view illustrating a punching apparatus for detecting a tool defect according to an embodiment of the present disclosure;

FIG. 2 is a block diagram illustrating a configuration of a defect detector that detects an abnormality such as the tool defect in the punching apparatus of FIG. 1;

FIG. 3 is a view illustrating a configuration example of a planar arrangement of measurers of the defect detector in the punching apparatus according to the embodiment of the present disclosure;

FIG. 4 is a diagram illustrating a flowchart for explaining an operation of a determination device of the defect detector in the punching apparatus according to the embodiment of the present disclosure;

FIG. 5A is a schematic diagram of a load profile generated in a punching process according to the embodiment of the present disclosure, and is a graph illustrating component forces in three-axis direction at the time of first (non-defect state) punching;

FIG. 5B is a schematic diagram of a load profile generated in the punching process according to the embodiment of the present disclosure, and is a graph illustrating the component forces in the three-axis direction at the time of punching after tool defect 1 occurs;

FIG. 5C is a schematic diagram of a load profile generated in the punching process according to the embodiment of the present disclosure, and is a graph illustrating the component forces in the three-axis direction at the time of punching after tool defect 2 occurs;

FIG. 6 is a view illustrating a display of a tool defect by a display of the defect detector in the punching apparatus according to the embodiment of the present disclosure;

FIG. 7A is a view illustrating a display of the tool defect by the display of the defect detector in the punching apparatus according to the embodiment of the present disclosure, and is a view illustrating a form displayed in order to distinguish a latest defect from a defect that occurred in the past;

FIG. 7B is a view illustrating a display of the tool defect by the display of the defect detector in the punching apparatus according to the embodiment of the present disclosure, and is a view illustrating a form displayed in order to distinguish a latest defect from the defect that occurred in the past; and

FIG. 7C is a view illustrating a display of the tool defect by the display of the defect detector in the punching apparatus according to the embodiment of the present disclosure, and is a view illustrating a form displayed in order to distinguish a latest defect from the defects that occurred in the past.

### DETAILED DESCRIPTIONS

In the technique of the related art illustrated in the above-mentioned Japanese Patent Unexamined Publication No. 55-48628, in the configuration of the punching apparatus of the related art, since only the load in the punching direction is measured, there is a problem that it is difficult to detect abnormality such as a tool defect or wear with high accuracy. From the viewpoint of further suppressing a malfunction of the punching apparatus, the configuration of the related art still has room for improvement.

Therefore, the present disclosure is provided to solve the above-mentioned problems of the related art, and an object thereof is to provide a punching apparatus that detects an abnormality such as a tool defect with high accuracy.

### Findings Forming Basis of Present Disclosure

The present inventors obtain the following new findings as a result of repeated research in order to detect, with higher accuracy, the abnormality such as the tool defect in the punching process.

In the punching process, the load in the punching direction is generally a force required for shearing a material and varies depending on a size of the punch/die for punching or a characteristic/thickness of the material of the workpiece, and is generally a relatively large value of 100 N or more. Even if the tool is slightly damaged or worn, since an amount of change in the load in the punching direction is small, the occurrence of the tool defect or wear cannot be easily detected. Therefore, since the punching apparatus of the related art is configured to detect the abnormality of the tool by measuring only the load in the punching direction, it is difficult to detect the occurrence of the tool defect or wear with high accuracy.

On the other hand, as will be described below in detail, among forces generated at the time of punching, a force generated in a plane orthogonal to a punching direction is very small compared to a load in the punching direction, so that a change in a load on the orthogonal plane can be easily detected. The present inventors found that the presence or absence of an abnormality such as a tool defect can be detected with high accuracy by measuring the force in the plane orthogonal to the punching direction. Based on this new finding, the present inventors reach the invention according to the following disclosure.

According to the first aspect of the present disclosure, a punching apparatus includes a punch and a die for forming a punching die for punching a predetermined shape from a workpiece, and performs a punching process for punching a shape of the punching die by the punch from the workpiece positioned on the die, the punching apparatus including: a detection device that includes a plurality of measurers and acquires a horizontal component force generated in a direction of each of two axes orthogonal to each other in a plane orthogonal to an axis along a punching direction of the punch, among forces generated when the workpiece measured by the plurality of measurers is punched; and a determination device that determines whether or not a defect occurs in the punch or the die based on the horizontal component force acquired by the detection device.

According to a second aspect of the present disclosure, there is provided the punching apparatus according to the first aspect, in which the number of the plurality of measurers is at least three, and in which each of the plurality of measurers is disposed on the same plane orthogonal to an axis along the punching direction.

According to a third aspect of the present disclosure, there is provided the punching apparatus according to the second aspect, in which each of the plurality of measurers is disposed in each of three regions among four regions divided by the two axes orthogonal to each other of the plane when the plane is viewed in the punching direction.

According to a fourth aspect of the present disclosure, there is provided the punching apparatus according to any one of the first to third aspects, in which the determination device includes a horizontal component force calculator, and in which the horizontal component force calculator calculates a difference between a horizontal component force obtained at the time of first punching and a horizontal component force obtained at the time of the punching in a direction of each of the two axes orthogonal to each other based on the horizontal component forces obtained by the detection device.

According to a fifth aspect of the present disclosure, there is provided the punching apparatus according to any one of the first to fourth aspects, in which the determination device includes a horizontal component force calculator, and in which the horizontal component force calculator calculates a difference between a horizontal component force obtained at the time of one previous punching and a horizontal component force obtained at the time of the punching in a direction of each of the two axes orthogonal to each other based on horizontal component forces continuously obtained by the detection device, in a continuous punching process.

According to a sixth aspect of the present disclosure, there is provided the punching apparatus according to the fourth or fifth aspect, in which the determination device further includes a defect determiner, and in which the defect determiner determines that the defect occurs when the difference between the horizontal component forces calculated by the horizontal component force calculator is larger than a preset determination reference value.

According to a seventh aspect of the present disclosure, there is provided the punching apparatus according to the sixth aspect, in which the horizontal component force calculator calculates a size of the defect and a direction of the defect on a tip surface of the punch or an upper surface of the punching die with respect to a predetermined reference position, when it is determined that the defect occurs by the defect determiner, and in which when differences between the horizontal component forces generated in a direction of each of an X-axis and a Y-axis, which are the two axes orthogonal to each other are denoted by dX and dY, the size s of the defect and the direction θ of the defect with respect to the X-axis respectively satisfy the following expressions.

$$\begin{matrix}s = \sqrt{{dX}^{2} + {dY}^{2}} & [ Equation 1 ] \\ θ = arctan ( \frac{dY}{dX} ) & [ Equation 2 ]\end{matrix}$$

According to an eighth aspect of the present disclosure, there is provided the punching apparatus according to the seventh aspect, in which each of the plurality of measurers is disposed so as to be evenly spaced from the reference position in the direction of each of the two axes orthogonal to each other.

According to a ninth aspect of the present disclosure, there is provided the punching apparatus according to the eighth aspect, in which the reference position is a center position or a centroid position of the punch.

According to a tenth aspect of the present disclosure, there is provided the punching apparatus according to any one of the seventh to ninth aspects, in which the determination device further includes a display that displays a calculation result by the horizontal component force calculator, and in which the display displays the size of the defect and/or the direction of the defect with a mark indicating the defect.

According to an eleventh aspect of the present disclosure, there is provided the punching apparatus according to the tenth aspect, in which the display displays a shape of the punch or the punching die as viewed in the punching direction, and displays the mark so as to be superimposed on the shape.

According to a twelfth aspect of the present disclosure, there is provided the punching apparatus according to the eleventh aspect, in which the display displays the mark at a position where the direction of the defect and a contour of the shape intersect.

According to a thirteenth aspect of the present disclosure, there is provided the punching apparatus according to any one of the tenth to twelfth aspects, in which the display displays a latest defect and a past defect generated in a continuous punching process with different marks.

According to a fourteenth aspect of the present disclosure, there is provided the punching apparatus according to any one of the tenth to thirteenth aspects, in which the display displays the mark by changing a size of the mark based on the size of the defect.

Hereinafter, embodiments of the present disclosure will be described with reference to the drawings. Each of the embodiments described below illustrates a preferred specific example of the present disclosure. Therefore, numerical values, shapes, materials, constituent elements, arrangement positions of constituent elements, connection forms, and the like illustrated in the following embodiments are specific examples according to the present disclosure, and do not limit the present disclosure. Therefore, among the constituent elements in the following embodiments, constituent elements that are not described in the independent claim illustrating the highest concept of the present disclosure are described as optional constituent elements.

Each drawing is a schematic view and is not necessarily strictly illustrated. In each drawing, the substantially same configurations are denoted by the same reference numerals, and overlapping description will be omitted or simplified.

### Embodiments

First, an overall structure of the punching apparatus according to the embodiment of the present disclosure will be described.

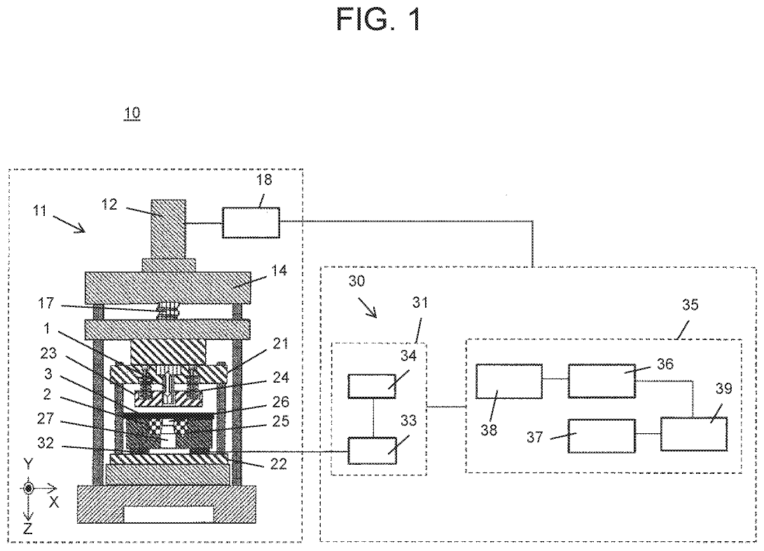

FIG. 1 is a partial front sectional view illustrating a punching apparatus for detecting a tool defect according to an embodiment of the present disclosure.

Punching apparatus 10 illustrated in FIG. 1 is in a state in which a punching die is mounted. Punching apparatus 10 includes processor 11 and defect detector 30. Upper die 21 in processor 11 is attached to a lower surface of movable plate 14, and movable plate 14 is connected to servomotor 12 via ball screw 17. Servomotor 12 is operated by an optional program in controller 18 of processor 11 and ball screw 17 is rotated to drive movable plate 14 up and down at a predetermined speed. Punch 1 is held by upper die 21 with respect to movable plate 14. Stripper 23 is held by compression spring 24 so as to face the lower surface of upper die 21. An upper part of punch 1 is held by upper die 21 with respect to movable plate 14, and a lower part thereof extends through stripper 23.

Die base 25 is attached to an upper surface of lower die 22 in a main body of punching apparatus 10 so as to face upper die 21. Die 2 is assembled on the upper part of die base 25, and at a position where a tip of punch 1 is inserted into die base 25 without interference, die 2 forms punching die 26 so as to have a more constant draft. Penetrating portion 27 is provided at a position corresponding to punching die 26 below die base 25. Workpiece 3 is placed on the upper surface of die base 25 and punched. Measurer 32 is attached to a lower portion of die base 25 and measures a force generated when the workpiece is punched.

Next, a punching operation in the present embodiment will be described below. When a punching program in controller 18 is executed, servomotor 12 is operated and ball screw 17 is driven to rotate. Therefore, movable plate 14 of punching apparatus 10 is lowered, and upper die 21 attached to movable plate 14 is interlocked. Stripper 23 comes into contact with workpiece 3 placed on the upper surface of die base 25, workpiece 3 is strongly pressed by deformation of compression spring 24. Punch 1 is protruded downward through stripper 23 by lowering of upper die 21 and comes into contact with workpiece 3 from above, and the punching operation starts. When the tip of punch 1 completely enters die 2, the operation of punch 1 is temporarily stopped. The punched workpiece (not illustrated in FIG. 1) passes through punching die 26 and falls into lower penetrating portion 27.

After reaching a lowest point (bottom dead center), punch 1 rises at a predetermined speed and returns to an original position by a control program. At this time, similarly to a general punching apparatus, stripper 23 presses workpiece 3 and acts so that workpiece 3 does not rise as punch 1 pulls out of an inside of workpiece 3. After that, stripper 23 rises, workpiece 3 is released, and workpiece 3 is fed in a predetermined direction by a predetermined dimension, or replaced (not illustrated). The punching process is performed as described above.

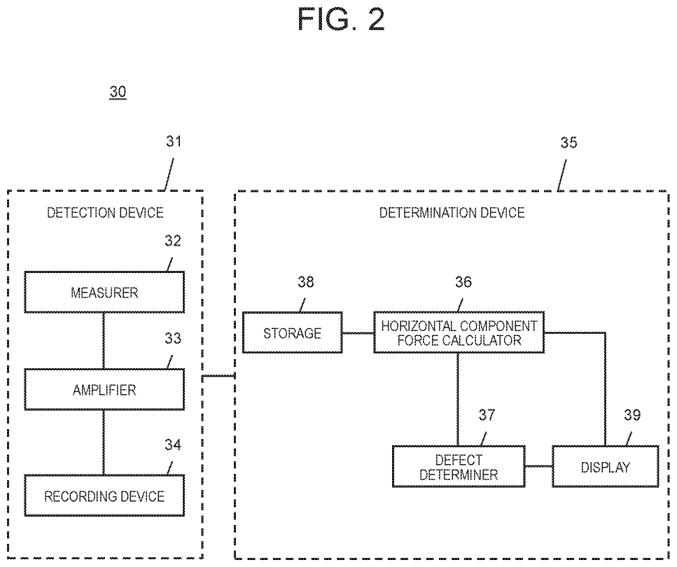

FIG. 2 is a block diagram illustrating a configuration of defect detector 30 that detects an abnormality such as a tool defect in punching apparatus 10 of FIG. 1.

As illustrated in FIG. 2, defect detector 30 includes detection device 31 and determination device 35. Detection device 31 includes measurer 32, amplifier 33, and recording device 34, and acquires information regarding a force generated when the workpiece is punched. Detection device 31 is electrically connected to determination device 35. Determination device 35 includes horizontal component force calculator 36, defect determiner 37, storage 38, and display 39, determines whether or not a defect of punch 1 or die 2 occurs based on detection information of detection device 31. When it is determined that punch 1 or die 2 is defective, display 39 displays a calculation result regarding the defect. As illustrated in FIG. 1, defect detector 30 can operate in synchronization with processor 11 by electrically connecting to controller 18 of processor 11. Hereinafter, a configuration and an operation of defect detector 30 will be described in detail.

Measurer 32 of detection device 31 may be, for example, a crystal-type sensor capable of high-speed response, which can measure a load generated when the workpiece is punched in directions of three orthogonal axes (X-, Y-, and Z-axis). In the present disclosure, in order to detect the tool defect, it is not necessary to measure the load in the Z-axis direction which is the punching direction illustrated in FIG. 1. However, since the measurement of the load in the punching direction is important in the punching process, preferably, measurer 32 is constituted of a three-axis load sensor which is firmly attached to die base 25, and is capable of accurately measuring the load in the punching direction (Z direction in FIG. 1) as well as loads in the directions of two axes (X- and Y-axis in FIG. 1) in the plane orthogonal to the punching direction.

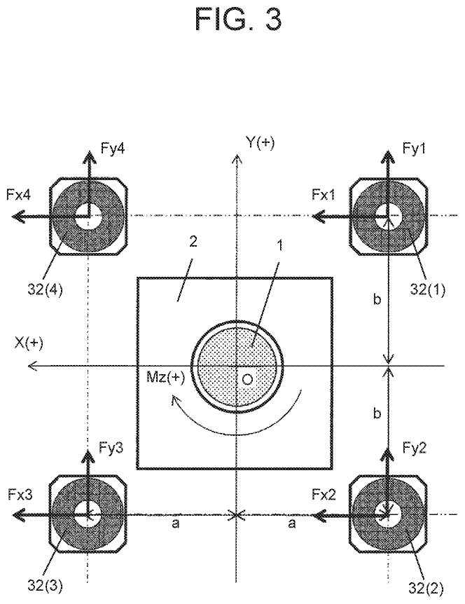

FIG. 3 is a view illustrating a configuration example of a planar arrangement of measurers 32 of defect detector 30 in punching apparatus 10 according to the embodiment of the present disclosure, and four measurers 32(1), 32(2), 32(3), and 32(4) are illustrated. A plane orthogonal to the punching direction (Z-axis) of the punch illustrated in FIG. 1 is defined as an X-Y plane, and four measurers 32 are disposed in a quadrangle on the plane. That is, measurer 32 is disposed in each of regions from a first quadrant to a fourth quadrant on the X-Y plane.

It is desirable that four measurers 32 are disposed so that a center position thereof coincides with a center position or centroid position O of the tip surface of punch 1 parallel to the X-Y plane. By disposing in this way, in a case where the tool defect occurs, the calculation of the direction of the defect, which will be described later, becomes easy, and the accuracy of detecting the defect is improved.

As illustrated in FIG. 3, respective measurers 32 are disposed such that distances therebetween are (a+a) in the X direction and (b+b) in the Y direction, and distances a and b may be equal. Shapes of the punching dies formed by punch 1 and die 2 illustrated in FIG. 3 are both simple circles, but the present disclosure is not limited to this and may have other shapes.

Although four measurers 32 are disposed in the present embodiment, if the number of measurers 32 is three or more, it is possible to calculate the horizontal component forces in the three-axis direction described later. In a case where three measurers 32 are used, three measurers 32 may be disposed at three positions which are not on a straight line. For example, three measurers 32 are respectively disposed in three regions of the four regions from the first quadrant to the fourth quadrant on the X-Y plane. Since the smaller the number of measurers 32 is, the cheaper it is, it is preferable to use three to four measurers. When the punching process is performed after these measurers are disposed, it is possible to measure the forces in the three-axis direction generated when the workpiece is punched, with each of the measurers.

### Experiment

The following experiment was carried out on how much the forces in the three-axis direction generated when the workpiece is punched are actually measured by measurers 32 when punch 1 or die 2 is defective.

In this experiment, first, a workpiece was a stainless steel plate (SUS304) having a thickness of 0.2 mm, and the punching process was performed using a circular punch having a diameter of 4.5 mm and having no defect. In this case, the load in punching direction Z was substantially 4000 N, and the load on the X-Y plane was 5 N. Next, the same workpiece was similarly punched using a punch having a defect. In this case, the load in punching direction Z was not significantly different from that in the case where there was no tool defect. On the other hand, the load on the X-Y plane changed by 10 to 40 N.

In this experiment, it is considered that the load in punching direction Z is also slightly changed due to the occurrence of the tool defect, like the load on the X-Y plane. However, even if a maximum load in punching direction Z is 4000 N and the change in load due to the punch defect is substantially 40 N at maximum, an influence on the load in punching direction Z is 1% or less, which is very small. That is, an S/N ratio (signal to noise ratio) is very small. Therefore, it is difficult to determine the influence of the tool defect from the change in the load in the punching direction.

On the other hand, the load on the X-Y plane was 5 N in a case where a punch with no defect was used, whereas a change of 10 to 40 N generated due to the occurrence of tool defect. Therefore, in order to detect the presence or absence of the tool defect, by measuring the load on the X-Y plane, a large S/N ratio can be obtained, and the presence or absence of the tool defect can be determined with higher accuracy.

As described above, by disposing at least three measurers 32, detection device 31 can acquire the horizontal component force of the X-Y plane among the forces generated when the workpiece is punched. The forces in the three-axis direction measured by measurers 32 are amplified by amplifier 33 and recorded in recording device 34 (for example, a data logger). Next, determination device 35 determines whether or not punch 1 or die 2 is defective based on the horizontal component force acquired by detection device 31.

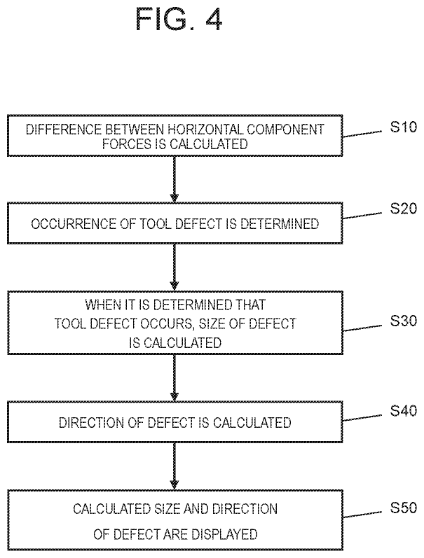

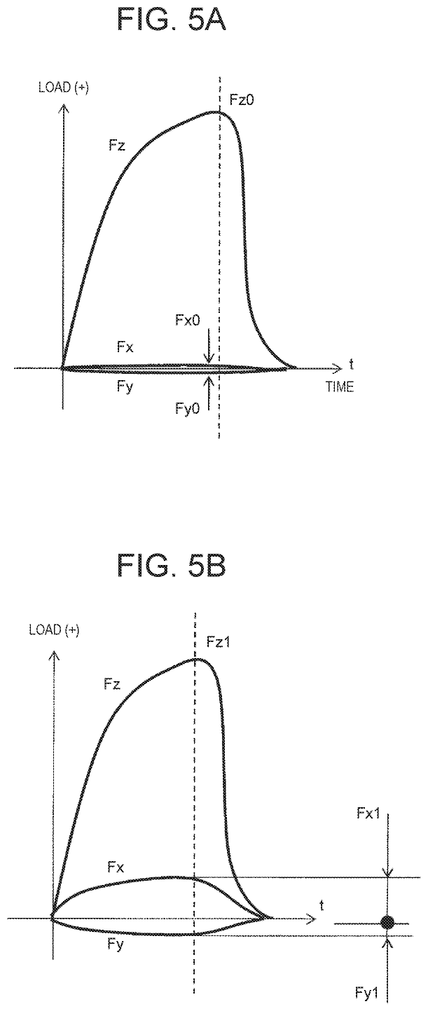

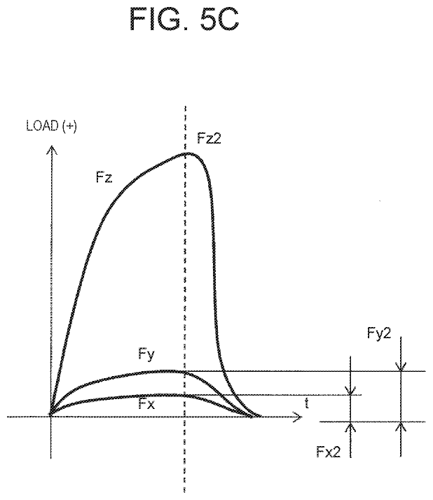

FIG. 4 is a flowchart illustrating an operation of determination device 35 of defect detector 30 in punching apparatus 10 according to an embodiment of the present disclosure. Step S10 of an operation process of determination device 35 illustrated in FIG. 4 is executed by horizontal component force calculator 36. In step S10, a difference between the horizontal component forces is calculated based on the horizontal component forces acquired by detection device 31. The calculation of the difference in horizontal component forces will be described below with reference to FIGS. 5A to 5C.

In a case where four measurers 32 are disposed as illustrated in FIG. 3, the component forces (Fx, Fy, and Fz) in the three-axis direction generated when the workpiece is punched and moment Mz about the Z-axis are calculated by following formulas.

[Equation 3]

Fz=Fz+Fz2+Fz3+Fz4 (1)

Fy=Fy1+Fy2+Fy3+Fy4 (2)

Fx=Fx1+Fx2+Fx3+Fx4 (3)

Mz=a((Fy3+Fy4)−a(Fy1+Fy2))+b((Fx2+Fx3)−b(Fx1+Fx4)) (4)

Here, Fx1, Fx2, Fx3, and Fx4 are component forces in the X-axis direction acquired based on the load values of the X-axis measured by four measurers 32, respectively. Numbers 1 to 4 correspond to four measurers. Fy1, Fy2, Fy3, and Fy4 are component forces in the Y-axis direction acquired based on the load values of the Y-axis measured by four measurers 32, respectively. Fz1, Fz2, Fz3, and Fz4 are component forces in the Z-axis direction acquired based on the load values of the Z-axis measured by four measurers 32, respectively. “a” and “b” are distances at which the respective measurers 32 are separated from center position O on the X-axis and the Y-axis illustrated in FIG. 3.

It is adjusted at the start of the process, such that a clearance (which is the distance between the punching die formed by die 2 and punch 1) between punch 1 and die 2 illustrated in FIG. 3 is uniform, sharpness of cutting edges of punch 1 and die 2 is uniform, the thickness of the workpiece is uniform, characteristics of the material, and the like are uniform. In this case, at the time of the punching process, the equations (2) to (4) are substantially “0” (zero). That is, a load other than the force in the Z direction (equation (1)), which is the load in the punching direction, does not occur. In the punching apparatus of the related art, as described above, the reason why the loads other than the load in the punching direction (Z-axis) are not measured is based on the assumption that only the load in the punching direction is generated.

FIG. 5A is a schematic diagram of a load profile generated in a punching process according to an embodiment of the present disclosure, and the component forces in the three-axis direction at the time of the first (non-defect state) punching are illustrated. In this state, the loads of the X-axis and Y-axis are not generated on the assumption that the adjustment at the start of the process is performed. That is, at the time of the first punching, the horizontal component forces when load Fz in the punching direction (Z-axis) reaches maximum load Fz(0) are set to initial values Fx(0) and Fy(0) of the horizontal component forces, and the values of Fx(0) and Fy(0) are both “0”.

When tool defect 1 occurs during the punching process, the load profile changes from a state of FIG. 5A to a state of FIG. 5B. FIG. 5B is a schematic diagram of a load profile generated in the punching process according to the embodiment of the present disclosure, and the component forces in the three-axis direction at the time of the punching after tool defect 1 occurs are illustrated. Horizontal component forces Fx and Fy are generated due to the occurrence of the tool defect. Here, horizontal component forces when load Fz in the punching direction (Z-axis) reaches maximum load Fz(1) are Fx(1) and Fy(1). The characteristic of this change is that load Fz in the punching direction (Z-axis) is generally a large value, so that even if the tool defect occurs, a change amount of the load on the Z-axis is 1% or less of the load value thereof. Therefore, it is difficult to detect the tool defect from the change in the load in the punching direction (Z-axis). On the other hand, loads Fx and Fy on the X-axis and the Y-axis, which are horizontal component forces, are smaller than the load in the punching direction (Z-axis) by two or more digits. Specifically, in the non-defect state, initial values Fx(0) and Fy(0), which were “0” value, are changed to constant values Fx(1) and Fy(1) (specifically, they vary depending on the degree of tool defect, or the like, and vary substantially from 1 to 30 N) due to the occurrence of the tool defect. Therefore, after tool defect 1 occurs, the horizontal component forces Fx(1) and Fy(1) that are relatively larger than those in the initial state can be detected, and differences dFx and dFy of the horizontal component forces with respect to the initial state can be easily calculated.

The state of FIG. 5B continues for a while unless the number of tool defects increases. When new tool defect 2 occurs, the state illustrated in FIG. 5B changes to that illustrated in FIG. 5C. FIG. 5C is a schematic diagram of a load profile generated in the punching process according to the embodiment of the present disclosure, and the component forces in the three-axis direction at the time of punching after the tool defect 2 occurs are illustrated. With respect to this state change, similarly to the above description, the change in load Fz in the punching direction (Z-axis) is small, and the horizontal component forces Fx(2) and Fy(2) when Fz reaches maximum load Fz(2) after tool defect 2 occurs are detected. Therefore, differences dFx and dFy of the horizontal component forces can be easily calculated.

Next, in step S20 of the operation process illustrated in FIG. 4, it is determined that the tool defect occurs. The determination is performed by defect determiner 37 of determination device 35. In the present embodiment, defect determiner 37 can perform both the determination of the occurrence of the tool defect in the initial state and the determination of the occurrence of the tool defect for each punching operation in the continuous punching process. Hereinafter, each determination process will be described.

First, in the determination of the occurrence of the tool defect in the initial state, initial values Fx(0) and Fy(0) of the horizontal component forces of the X-axis and the Y-axis when Fz reaches maximum load Fz(0) at the time of the first punching are stored in storage 38. Horizontal component force calculator 36 calculates differences dFx and dFy of the horizontal component forces with respect to the stored initial values Fx(0) and Fy(0). Specifically, in an nth punching process, detection device 31 acquires horizontal component forces Fx(n) and Fy(n) of the X-axis and the Y-axis when Fz reaches maximum load Fz(n). Horizontal component force calculator 36 calculates difference dFx of the horizontal component force as (Fx(n)−Fx(0)) with respect to stored initial values Fx(0) and Fy(0), and dFy is calculated as (Fy(n)−Fy(0)). Similarly, for an (n+1)th punching process, differences dFx and dFy of the horizontal component forces are calculated as (Fx (n+1)−Fx(0)) and (Fy (n+1)−Fy(0)), respectively. In a case where calculated dFx or dFy is larger than preset determination reference value 1, defect determiner 37 can determine that the tool defect occurs in the initial state at the time of the determination. In this way, at the time of the determination, whether or not the defect occurs is determined as a comprehensive influence based on the change with respect to the initial state.

Next, in the continuous punching process, the determination of the occurrence of the tool defect for each punching operation is performed as follows. Specifically, in the nth punching process, the horizontal component forces Fx(n) and Fy(n) of the X-axis and the Y-axis when Fz reaches maximum load Fz(n), acquired by detection device 31, are stored in storage 38. Next, in the (n+1)th punching process, detection device 31 acquires horizontal component forces Fx (n+1) and Fy (n+1) of the X-axis and the Y-axis when Fz reaches maximum load Fz (n+1). Horizontal component force calculator 36 calculates difference dFx of the horizontal component forces as (Fx (n+1)−Fx(n)) with respect to stored Fx(n) and Fy(n), and dFy is calculated as (Fy (n+1)−Fy(n)). In a case where calculated dFx or dFy is larger than preset determination reference value 2, defect determiner 37 can determine that the tool defect occurs in the (n+1)th punching operation. The values of Fx(n) and Fy(n) stored in storage 38 are updated, and as new Fx(n) and Fy(n), values of Fx(n+1) and Fy(n+1) acquired in the (n+1)th punching process are stored in storage 38, and the above-described calculation is repeated. In this way, in the continuous punching process, by performing a series of processes for each punching operation, the difference in horizontal component forces is calculated one after another, and it is possible to detect a tool defect that newly occurs for each punching operation.

In the present embodiment, it is possible to specify to determination device 35 whether to determine the occurrence of the tool defect in the initial state and/or to determine the occurrence of the tool defect for each punching operation. Defect determiner 37 can set a determination reference value. Ideally, when an absolute value of difference dFx or dFy in the horizontal component forces at the time of the punching with respect to the initial state becomes a value larger than “0”, the occurrence of the tool defect is indicated. However, it is desirable to set the determination reference value to a value larger than “0” in consideration of fluctuation in actual measurement reproducibility, variation, or the like in the process. Specifically, for example, determination reference value 1 or determination reference value 2 can be set to 5 N. The determination reference values in the X-axis direction and the Y-axis direction may be set to different values according to an actual processing request. Determination reference value 1 and determination reference value 2 may be set to the same value or different values. From the values of differences dFx and dFy of the horizontal component forces, a resultant force of the differences of the horizontal component forces on the X-Y plane described below can be calculated. With respect to a size of the resultant force, it is also possible to set a determination reference value and determine the occurrence of the tool defect (not illustrated).

Subsequently, in step S30 of the operation process illustrated in FIG. 4, when it is determined that the tool defect occurs, horizontal component force calculator 36 calculates a size of the defect. The size of the defect is represented by the size of the resultant force of the differences dFx and dFy of the horizontal component forces on the X-Y plane, and is calculated by the following formula.

s=\sqrt{dFx2+dFy²} [Equation 4]

Defect determiner 37 can classify the value of calculated defect size into a plurality of ranks and determine a level of the tool defect. Specifically, for example, in a case where a calculated value of s is less than 10 N, it may be determined as level 1, in a case where the value is 10 N or more and less than 20 N, it may be determined as level 2, and in a case where the value is 20 N or more and less than 30 N, it may be determined as level 3. It is desirable to display the determination result of the level of the tool defect on the display which will be described later. In a case where many high-level defects occur, it is estimated that there are many large tool defects in the punch, and it can be determined that, for example, large burrs may occur in a punched product.

Then, in step S40 of the operation process illustrated in FIG. 4, the direction of the defect is further calculated. The direction of the defect is calculated by horizontal component force calculator 36 based on the differences dFx and dFy of the horizontal component forces on the X-Y plane by the following formula.

$$θ = arctan ( \frac{dFy}{dFx} ) \qquad [ Equation 5 ]$$

Angle θ calculated by the above formula is an angle representing the direction of the position where the tool defect occurs on the tip surface of punch 1 or the upper surface of punching die 26 with respect to a predetermined reference position. The reference position used to calculate the position of the tool defect can be the center position where the measurers are disposed, for example, center position O of four measurers 32 illustrated in FIG. 3. Generally, by disposing each of the measurers so as to be evenly spaced from the selected reference position in the X-axis direction and the Y-axis direction, the direction of the defect can be easily calculated. The reference position preferably coincides with the center position or the centroid position of the punch.

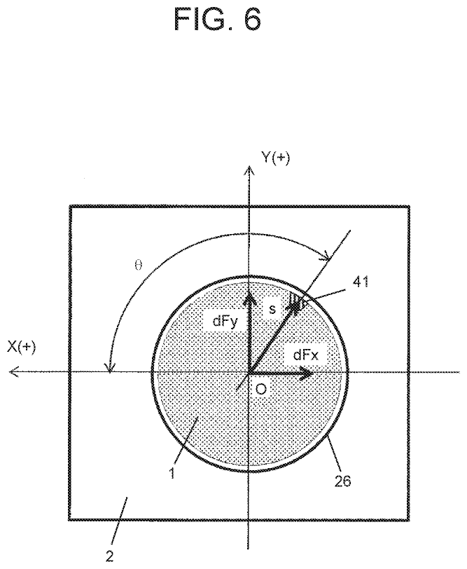

Subsequently, in step S50 of the operation process illustrated in FIG. 4, the calculated size and direction of the defect are displayed by display 39. FIG. 6 is a view illustrating a display of a tool defect by display 39 of defect detector 30 in punching apparatus 10 according to the embodiment of the present disclosure. Hereinafter, a display form of the size and the direction of the tool defect calculated by horizontal component force calculator 36 will be described with reference to FIG. 6.

A coordinate system of FIG. 6 corresponds to the coordinate system of the planar arrangement of the measurers according to FIG. 3.

According to FIG. 6, a contour of the tool punch (or die) used for the punching process is displayed on display 39. In the present embodiment, the contour of punching die 26 formed by punch 1 or die 2 is displayed as a circle. In a case where the tool used for the punching process has another shape, it is desirable to display the same shape as the contour of the tool on display 39.

Display 39 displays first mark 41 indicating a first tool defect based on a calculation result of horizontal component force calculator 36. As described above, θ calculated based on differences dFx and dFy of the horizontal component forces on the X-Y plane is an angle representing the direction in which the defect occurs, and a coordinate value in which the tool defect occurs cannot be specified. However, it is presumed that the tool defect occurs at an edge portion of the tool, which becomes the cutting edge. Therefore, as illustrated in FIG. 6, by displaying first mark 41 at a position where the edge portion (or an inner edge of die 2) of punch 1 and the calculated angle representing the direction of the defect intersect, it is possible to indicate the position where the tool defect occurs.

The size s of the defect calculated by horizontal component force calculator 36 can be displayed in association with the size of first mark 41. The level of the tool defect determined by defect determiner 37 may be displayed in correlation with first mark 41 (for example, by color or size).

It is difficult to specify whether the tool defect occurs on a punch side or a die side, because the action and the reaction coexist in the change in the load due to the tool defect. Therefore, in display 39, both punch 1 and die 2 may be displayed, and first mark 41 may be displayed on either or both of the punch side and the die side.

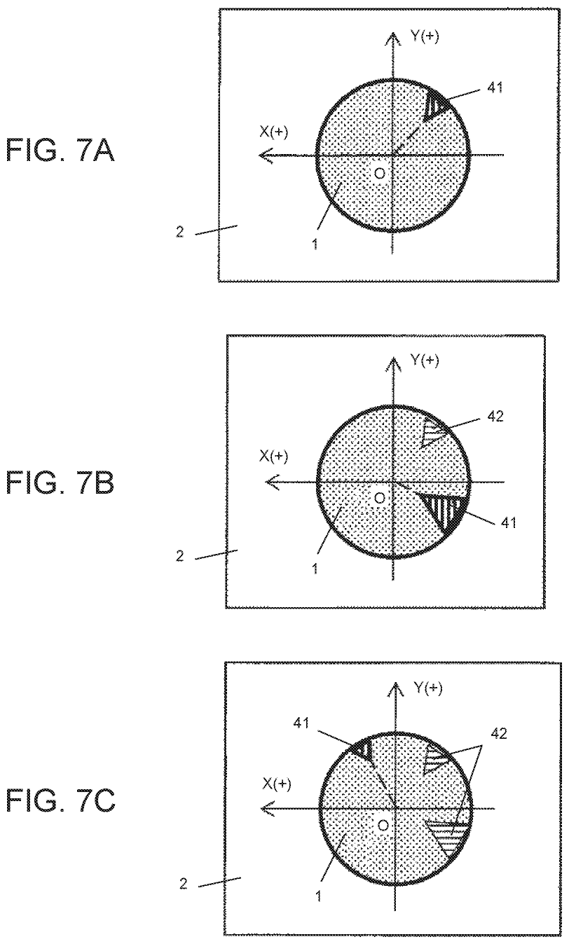

FIGS. 7A to 7C are views illustrating a display of a tool defect by display 39 of defect detector 30 in punching apparatus 10 according to the embodiment of the present disclosure, and are views illustrating a form that displays the latest defect so as to be distinguished from the defect that occurred in the past. When defect determiner 37 determines that the first tool defect occurs, as illustrated in FIG. 7A, the calculation result for tool defect 1 by horizontal component force calculator 36 is displayed by first mark 41.

Next, as illustrated in FIG. 7B, when defect determiner 37 determines that the second tool defect occurs, display 39 displays first mark 41 at the position where the second tool defect occurs, and displays second mark 42 at the position of the first tool defect. That is, display 39 changes the display so that the difference between the latest tool defect and the tool defect that occurred in the past can be identified. First mark 41 and second mark 42 may be displayed so as to be more easily identified, for example, by being displayed in different colors or shapes from each other.

FIG. 7C illustrates a schematic view of a display form of display 39 when a third defect occurs. When defect determiner 37 determines that the third tool defect occurs, display 39 displays first mark 41 at a position where the third tool defect occurs, and displays second marks 42 at positions where the first and second tool defects occur. That is, display 39 changes the display so that the difference between the latest tool defect and the tool defect that occurred in the past can be identified. Display 39 may change the display so that the first tool defect and the second tool defect can be further identified. That is, display 39 may display the tool defect determined by defect determiner 37 so that a generated time series order can be identified.

The size of the defect may be expressed by changing the sizes of first mark 41 and second mark 42 so that the size of the defect calculated by horizontal component force calculator 36 can be determined.

As described above, the punching apparatus according to the present disclosure determines whether or not a tool defect occurs with respect to the initial state or for each punching operation, and in a case where the defect occurs, a display can be added so that the position and size of the defect are displayed on the display. In this way, it is possible to grasp the occurrence status of tool defect during the punching process. By analyzing the occurrence state of the tool defect, it is possible to estimate a possibility that quality deterioration occurs in the punched workpiece (product side), and it is possible to accurately determine a tool replacement time, or the like. Therefore, it is possible to realize a high quality punching process.

In the embodiment of the present disclosure described above, measurer 32 is configured to be incorporated in lower die 22 and measure the load generated on die 2, but the present disclosure is not limited to this. For example, it goes without saying that measurer 32 may be incorporated in upper die 21 to measure the load generated on the punch. In this case, since the spring load of stripper 23 is not measured, only the punching load can be measured.

In the above description, as one of the determination methods for whether or not a tool defect occurs, an embodiment is described in which the horizontal component force acquired at the time of the first punching is used as a determination reference to determine the occurrence of the tool defect with respect to the initial state of the process. However, the present disclosure is not limited thereto. For example, not only the horizontal component force acquired at the time of the first punching in the actual process, but also the horizontal component force acquired at the time of any one punching before the determination is used as the determination reference, and it is also possible to determine the occurrence of the tool defect thereafter.

The present disclosure is not limited to the above embodiments, and can be implemented in various other modes. For example, in the above description, the punching process in which the processor has a closed curve is described as an example, but the present disclosure is not limited to this. For example, the same effect can be obtained even if the processor, which has a closed curve, is used for a cutting process.

While the present disclosure are fully described in connection with the preferred embodiments with reference to the accompanying drawings, various variations and modifications will be apparent to those skilled in the art. It is to be understood that such variations and modifications are within the scope of the claims of the present disclosure unless they depart from the scope of the disclosure of the appended claims.

According to the punching apparatus of the present disclosure, it is possible to detect a tool defect with high accuracy by detecting the force generated in the horizontal plane orthogonal to the punching direction. Furthermore, the punching apparatus of the present disclosure is not limited to the punching process, and can be widely applied to detection of a tool defect during a cutting process, a three-axis load measurement during a bending process, or the like.

What is claimed is:

1. A punching apparatus, which includes a punch and a die for forming a punching die for punching a predetermined shape from a workpiece, and performs a punching process for punching a shape of the punching die by the punch from the workpiece positioned on the die, the punching apparatus comprising:
a detection device that includes a plurality of measurers and acquires a horizontal component force generated in a direction of each of two axes orthogonal to each other in a plane orthogonal to an axis along a punching direction of the punch, among forces generated when the workpiece measured by the plurality of measurers is punched; and
a determination device that determines whether or not a defect occurs in the punch or the die based on the horizontal component force acquired by the detection device.

2. The punching apparatus of claim 1,
wherein the number of the plurality of measurers is at least three, and
wherein each of the plurality of measurers is disposed on the same plane orthogonal to an axis along the punching direction.

3. The punching apparatus of claim 2,
wherein each of the plurality of measurers is disposed in each of three regions among four regions divided by the two axes orthogonal to each other of the plane when the plane is viewed in the punching direction.

4. The punching apparatus of claim 1,
wherein the determination device includes a horizontal component force calculator, and
wherein the horizontal component force calculator calculates a difference between a horizontal component force obtained at the time of first punching and a horizontal component force obtained at the time of the punching in a direction of each of the two axes orthogonal to each other based on the horizontal component forces obtained by the detection device.

5. The punching apparatus of claim 1,
wherein the determination device includes a horizontal component force calculator, and
wherein the horizontal component force calculator calculates a difference between a horizontal component force obtained at the time of one previous punching and a horizontal component force obtained at the time of the punching in a direction of each of the two axes orthogonal to each other based on horizontal component forces continuously obtained by the detection device, in a continuous punching process.

6. The punching apparatus of claim 4,
wherein the determination device further includes a defect determiner, and
wherein the defect determiner determines that the defect occurs when the difference between the horizontal component forces calculated by the horizontal component force calculator is larger than a preset determination reference value.

7. The punching apparatus of claim 6,
wherein the horizontal component force calculator calculates a size of the defect and a direction of the defect on a tip surface of the punch or an upper surface of the punching die with respect to a predetermined reference position, when it is determined that the defect occurs by the defect determiner, and
the size s of the defect and the direction θ of the defect with respect to the X-axis is obtained by
$$\begin{matrix}s = \sqrt{{dX}^{2} + {dY}^{2}} \\ and & Formula ( 1 ) \\ θ = arctan ( \frac{dY}{dX} ) & Formula ( 2 )\end{matrix}$$
where dX and dY represents differences between the horizontal component forces generated in a direction of each of an X-axis and a Y-axis, which are the two axes orthogonal to each other.

8. The punching apparatus of claim 7,
wherein each of the plurality of measurers is disposed so as to be evenly spaced from the reference position in the direction of each of the two axes orthogonal to each other.

9. The punching apparatus of claim 8
wherein the reference position is a center position or a centroid position of the punch.

10. The punching apparatus of claim 7,
wherein the determination device further includes a display that displays a calculation result by the horizontal component force calculator, and
wherein the display displays the size of the defect and/or the direction of the defect with a mark indicating the defect.

11. The punching apparatus of claim 10,
wherein the display displays a shape of the punch or the punching die as viewed in the punching direction, and displays the mark so as to be superimposed on the shape.

12. The punching apparatus of claim 11,
wherein the display displays the mark at a position where the direction of the defect and a contour of the shape intersect.

13. The punching apparatus of claim 10,
wherein the display displays a latest defect and a past defect generated in a continuous punching process with different marks.

14. The punching apparatus of claim 10,
wherein the display displays the mark by changing a size of the mark based on the size of the defect.
